(19) United States
(12) Patent Application Publication
(10) Pub. No.: US 2026/0226360 A1
(43) Pub. Date: Aug. 6, 2026

(54) METHOD FOR CREATING A 3D PRINT USING ORGANIC ICE AND FOCUSED ELECTRON BEAM

(71) Applicant: Danmarks Tekniske Universitet, Kongens Lyngby (DK)

(72) Inventors: Anpan HAN, Kongens Lyngby (DK); Affan Kaysa WAAFI, Kongens Lyngby (DK); Joachim LYNGHOLM-KJAERBY, Kongens Lyngby (DK)

(73) Assignee: Danmarks Tekniske Universitet, Kongens Lyngby (DK)

(21) Appl. No.: 19/146,364

(22) PCT Filed: Apr. 17, 2024
(86) PCT No.: PCT/EP2024/060368

§ 371 Date: Jul. 8, 2025

(30) Foreign Application Priority Data
Apr. 21, 2023 (EP) 23169220.3

(51) Int. Cl. C10L 5/08; B33Y 10/00; B33Y 30/00; B33Y 40/20; B33Y 70/00

(52) U.S. Cl. CPC C10L 5/08; B33Y 10/00; B33Y 30/00; B33Y 40/20; B33Y 70/00; C10L 2200/0446

(57) ABSTRACT

The present invention relates to a method for 3D printing a digital representation of a 3D structure, the method comprising the steps of condensing a vapour into a first organic ice layer on the surface of a cooled substrate; exposing at least part of the first organic ice layer to at least one electron beam thereby forming one or more voxels in the first organic ice layer; wherein the one or more voxels is/are arranged in accordance with a first predetermined pattern; and wherein the one or more voxels remain essentially intact at ambient conditions; condensing a vapour into a second organic ice layer on the surface of the first organic ice layer, exposing at least part of the second organic ice layer to at least one electron beam thereby forming one or more voxels in the second organic ice layer, wherein the one or more voxels is/are arranged in accordance with a second predetermined pattern, and wherein the one or more voxels remain essentially intact at ambient conditions; and bringing the first and second organic ice layers to ambient conditions in order to evaporate nonexposed regions of the first and second organic ice layers; wherein the first and second predetermined patterns are defined by respective first and second G-codes derived from the digital representation of the 3D structure to be 3D printed. The present invention further relates to a method for 3D printing at room temperatures, and to 3D printers.

### FIELD OF THE INVENTION

The present invention relates to a layer-by-layer digital process using condensed organic vapours thin films as the starting material. The process uses a focused electron beam to chemically cross-link the organic ice into a solid and shares software and CAD databases with industrial 3D printing. Guided by electron-matter-interaction simulations, cross-linking thickness between 250 nm and 2 μm are controlled. The 3D prints contained up to 500 layers of organic vapours thin films, and the smallest structures manufactured are 550-nm-wide. The digital process of the present invention complements two-photon lithography in three areas; (i) it is compatible with chemicals beyond photopolymers, (ii) delicate suspended structures and tubes can be printed because the structures are not immersed in liquid resins that reside in cavities and destroy structures by interfacial forces, and (iii) hanging structures can be printed without sacrificial supports.

### BACKGROUND OF THE INVENTION

Additive manufacturing (AM) or 3D printing is an enabling technology that has revolutionized mechanical engineering and production by providing a digital method to create previously impossible products. Recent research had tremendous impacts on the production speed, photochemistry, advanced alloys, and fundamental understanding of AM science and processes.

Because of the inherent nature of photon-based AM processes, for submicrometer AM, two-photon lithography (TPL) has achieved great success thanks to advanced photopolymerization chemistry. TPL printing speed is greatly enhanced by advancing multi-beam technology. The photopolymerization process is an amplified chemical process such that each photon initiates a localized polymerization process that is terminated by chemical inhibitors.

One shortcoming of TPL and AM based on polymerization is its dependence on the delicate photoinitiation, polymerization, and termination chemistry that must be contained in a submicrometer voxel. Focused electron beam (e-beam) induced deposition (FEBID) takes full advantage of organic chemistry, and it is possible to 3D print metals, magnetic materials, and superconductors on the nanoscale.

FEBID is based on electron-gas-surface interactions, enabling monolayer control with the trade-off of a slow process. While FEBID enables 3D nanostructures, powder-based e-beam additive manufacturing (EBAM) technology is a golden standard for metal AM, and EBAM resolution is 20 μm.

Fundamentally different from FEBID and EBAM is ice lithography. In ice lithography (IL), water vapor condenses onto a cold substrate to form an ice thin film, which is patterned by an e-beam, and metallic nanostructures were fabricated using lift-off. Several layers of water ice have been used to make suspended metal structures.

Prior studies demonstrated that organic ices such as alcohols, aromatics, alkanes, and organometallic ices could be patterned by e-beam cross-linking, and hence IL is compatible with chemistry beyond photopolymers, which is required by e.g. TPL and stereolithography. The electrons in IL interact with the entire ice film, and therefore IL is more than 4 orders of magnitude faster than FEBID. Patterned 4-nm-wide lines with Ångstrom level line-edge roughness and 1 nm surface roughness have been reported. The size of the molecules and the stochastic nature of electron-ice interactions limit the ultimate resolution of IL. Organic ice thickness is controlled with 10 nm accuracy, and IL patterns on 3D objects. The drawback of traditional IL processes is the limited number of organic ice layers.

In previous work by the inventors, manually printed 2.5D structures consisting of 3 layers of organic ice using the EBL process were provided. Another research group has 3D printed four ice layers and demonstrated overhanging structures. Both studies used EBL processes and processing paradigms designed for 2D and greyscale patterning.

Unfortunately, TPL photopolymers are toxic, and IL chemicals are based on benign petrochemicals. Thus, there is a wish to move away from toxic and petrochemicals and thus provide nanoscale 3D printing methods that use low toxicity, renewable, and sustainable materials.

It may be seen as an object of embodiments of the present invention to provide a method for creating a 3D print in organic ice using a large number of organic ice layers.

It may be seen as a further object of embodiments of the present invention to provide a method for creating a complex 3D print in organic ice.

It may be seen as an even further object to provide a low carbon footprint and inexpensive scanning electron arrangements which will increase sustainability compared to current methods.

### DESCRIPTION OF THE INVENTION

The above-mentioned object is complied with by providing, in a first aspect, a method for 3D printing a digital representation of a 3D structure, the method comprising the steps of
a) condensing a vapour into a first organic ice layer on the surface of a cooled substrate;
b) exposing at least part of the first organic ice layer to at least one electron beam thereby forming one or more voxels in the first organic ice layer; wherein the one or more voxels is/are arranged in accordance with a first predetermined pattern; and wherein the one or more voxels remain essentially intact at ambient conditions;
c) condensing a vapour into a second organic ice layer on the surface of the first organic ice layer;
d) exposing at least part of the second organic ice layer to at least one electron beam thereby forming one or more voxels in the second organic ice layer, wherein the one or more voxels is/are arranged in accordance with a second predetermined pattern, and wherein the one or more voxels remain essentially intact at ambient conditions; and
e) bringing the first and second organic ice layers to ambient conditions in order to evaporate nonexposed regions of the first and second organic ice layers;

wherein the first and second predetermined patterns are defined by respective first and second G-codes derived from the digital representation of the 3D structure to be 3D printed.

Thus, the present invention relates to a method for 3D printing a digital representation or model of a 3D structure. The present invention is advantageous in that the use of G-codes facilitates that a very large number of organic ice layers, such as several hundreds of organic ice layers, may be used.

In the present context the term “condensing” should be understood as transforming a compound from a fluid phase to a solid phase. Also, the term “essentially intact” should be understood as essentially unmodified. Thus, by stating that the one or more voxels remain essentially intact means that the one or more voxels remain unchanged in terms of chemical properties as well as the state of matter when exposed to ambient conditions, such as room temperature which may be in the range 15-25° C.

In the present context a G-code should be understood as (x,y) coordinates that, in a given z-plane, define the predetermined pattern to be followed by the at least one electron beam.

The entire G-code file is generated when slicing the 3D structure to be printed into a stacked arrangement of layers of (x,y) coordinates. In the present context, the Hewlett Packard Graphics Language (HPGL), or similar approaches, is also considered G-codes as it is a vector-based graphic tool suitable for controlling for example printers, plotters and other output devices, including electron beams.

As already mentioned, the present invention is advantageous in that the use of G-codes facilitates that a very large number of organic ice layers, such as several hundreds of organic ice layers, may be used. Thus, the method may further comprise the steps of forming additional organic ice layers in accordance with step a), exposing each of these additional organic ice layers in accordance with step b), and evaporating nonexposed regions of these additional organic ice layers in accordance with step e). In fact the method may further comprise the steps of forming at least 10, such as at least 50, such as at least 75, such as at least 100, such as at least 150, such as at least 200, such as at least 300, such as at least 400, such as at least 500 additional organic ice layers in accordance with step a) and exposing each of these additional organic ice layers in accordance with step b), and evaporating nonexposed regions of these additional organic ice layers in accordance with step e). In general the organic ice layers may comprise different chemical compositions. Thus, as an example, the first organic ice layer may comprise a first chemical composition, and the second organic ice layer may comprise a second chemical composition, wherein the first and second chemical compositions are different.

The one or more voxels may have dimensions between 10 nm and 10000 nm, such as between 10 nm and 1000 nm, such as between 100 nm and 500 nm in a plane of the first, second and/or additional organic ice layers. The term “plane” is here to be understood as the extension of the organic ice layers essentially perpendicular to the growth direction during condensation of the vapour.

Potential candidates for the vapour are to be condensable under certain circumstances. Typically, the vapour comprises molecules with a molecular mass smaller than 1000 Daltons. The vapour may be created from one or more of the compounds which can be selected from the compounds mentioned in the following text books: Landolt-Bornstein: New Series, Neue Serie Group 4 Vol. 20a: Vapor Pressure of Chemicals, Landolt-Bornstein: New Series, Neue Serie Group 4 Vol. 20b: Vapor Pressure of Chemicals, Landolt-Bornstein: New Series, Neue Serie Group 4 Vol. 20c: Vapor Pressure of Chemicals and National Institute of Standards and Technology NIST WebBook.

The compounds from the above-mentioned references that may be used as a potential candidate for the vapour may need to fulfil a number of conditions. These conditions may include appropriate vapour pressure at 10, 80 or 150 K, appropriate vapour pressure at room temperature and appropriate vapour pressure at e.g. 100° C. These may be calculated from the Antoine equation. Reference value for all three pressure values may be water. The vapour pressure at 150 K may need to be low, preferably the same or lower than vapour pressure of water at 150 K which is 4.7e-10 Torr. Furthermore, this pressure may need to be lower than the vacuum pressure in a chamber where the compound is to be frozen (5e-6 Torr). The vapour pressure of the possible compounds at room temperature (298 K) needs to be similar to that of water which is 23 Torr. Preferably between 1 Torr and 760 Torr. If the vapour pressure of the compound at room temperature is too low, then it may not be possible to heat the compound to higher temperature, e.g. 100° C. and hence create higher vapour pressure and inject it into the chamber.

Furthermore, potential candidates for the vapour may belong to certain classes of chemicals. These classes may be: hydrocarbon C₆-C₁₆, sulfur containing compounds, halogen containing compounds, oxygen containing compounds, nitrogen containing compounds, monomers, and ALD and CVD precursors for metallic layers. Some of the compounds selected from these classes are listed in Table 1 below.

| | Vapour | Vapour | Vapour |
|---|---|---|---|
| | pressure at | pressure at | pressure at |
| Substance | 150K (Torr) | 298K (Torr) | 100° C. |
| Hydrocarbon | | | |
| C₆-C₁₆ | | | |
| Styrene | 2.3077E−09 | 5.773067627 | 176.2174522 |
| Naphtahalene | 1.09233E−15 | 0.219129087 | 17.24450241 |
| Decane (I) | 1.62471E−09 | 1.361723841 | 75.52514477 |
| Undecane | 4.33112E−17 | 2.563681564 | 212.3951506 |
| Sulfur containing | | | |
| compounds | | | |
| DMSO, | 7.21763E−12 | 0.623149877 | 40.07336622 |
| dimethylsulfoxide | | | |
| Cyclohexanethiol | 8.33755E−11 | 3.96703031 | 130.9172118 |
| Sulfur trioxide | 7.36621E−13 | 310.2552461 | |
| Halogen containing | | | |
| compounds | | | |
| Bromine trifluoride | 1.98599E−10 | 7.387608739 | 302.375888 |
| Xenon difluoride | 3.74027E−10 | 3.362243848 | 290.7093857 |
| Iodine | 6.15978E−13 | 0.250654554 | 37.68696869 |
| Hexachloropropene | 4.46385E−17 | 0.221503656 | 18.45940617 |
| C₁₀F₁₈ | 6.04962E−12 | 6.163955145 | 209.5897252 |
| Oxygen containing | | | |
| compounds | | | |
| Chlorine trioxide | 7.5E−09 | 1.697852557 | 34.72929268 |
| Water | 3.40519E−08 | 23.66483109 | 760.3501647 |
| 1-Propanol | 4.55191E−11 | 21.36026901 | 858.7856775 |
| 1-Pentanol | 1.60433E−24 | 1.906763656 | 178.8565595 |
| Methoxybenzene/ | 2.9212E−12 | 3.397280754 | 139.7881973 |
| anisole | | | |
| Nitrogen containing | | | |
| compounds | | | |
| Nitropropane | 2.01667E−09 | 9.821293764 | 280.4790192 |
| Monomers | | | |
| Styrene | 5.04474E−10 | 6.174580853 | 242 |
| ALD and CVD | | | |
| precursors for | | | |
| metalic layers | | | |
| Trimethylaluminum | 9.72E−08 | 10.426353 | |
| Diethylzinc | 4.11331E−07 | 20.0298286 | |

Vapour parameters which are of relevance for the organic ice layer creation are 1) vapour pressure at 150 K, 2) vapour pressure at 298 K, 3) triple point, 4) ionization cross-section at 10 keV and 5) ionization cross-section at 50 keV. Parameters such as vapour pressure at 150 K, vapour pressure at room temperature (298 K), and a vapour pressure at 100° C. are listed in a Table 1 below. The values for the vapour pressure are estimated with Antoine equation. A product of reaction between the vapour and an electron beam may be solid.

Typically, the vapour may be introduced into a high vacuum chamber via a gas injection system which may comprise a nozzle designed to control the vapour flow as it enters the vacuum chamber. Once the vapour gets in contact with the cooled substrate it will be condensed into an organic ice layer.

The substrate may have a planar surface, but may as well have a surface which is nonplanar. Despite the nonplanar surface of the substrate the organic ice layer will stick to the surface due to a good adhesion between the surface of the substrate and vapour deposited. Typically, the substrate may comprise a wafer, such as a standard 100 mm wafer. The wafer material may be silicon or other types of materials.

The substrate may be cooled to temperatures below 200 K, such as below 170, such as below 150K, such as below 130 K, such as below 110 K, such as below 90 K, such as around 80 K. It should though be noted that the substrate may be cooled to temperatures as low as 10 K, and the substrate may as well be heated to 350 K.

In order to cool the substrate a cryogenic system arranged in a high vacuum chamber may be used. Typically, high-vacuum chambers operate at pressures of around 10-6 Torr. Preferably, the vapour has a pressure which is on the order of 0.1-10 Torr at room temperature so that it can be introduced into the vacuum chamber via the above-mentioned gas injection system.

The cryogenic system may consist of a copper base that is cooled by thermal contact through an oxygen-free copper braid. The copper braid may be soldered or clamped to a cryogenic stage. The other end of the copper braid may also be either soldered or clamped onto a copper rod that may be immersed in a liquid-nitrogen, LN₂, which may be held in an external LN₂ Dewar.

Once condensed, the organic ice layers preferably have a vapour pressure smaller than the pressure in the high vacuum chamber in order to prevent sublimation. A thickness of the organic ice layers may be controlled both by controlling the temperature of the cryogenic stage and by controlling the amount of vapour introduced to the vacuum chamber.

The first, second and/or additional organic ice layers may comprise diesel (C₉H₂₀) ice layers.

Alternatively, or in combination therewith, the first, second and/or additional organic ice layers may comprise renewable chemicals, ethanol ice layers, nonane ice layers and/or fatty acids ice layers originating from vegetable oils.

An electron beam is considered a stable and well-focused beam of electrons with a high beam current and high energy. The electron beam may change the chemical structure and thereby the chemical composition of the exposed regions of the organic ice layers. According to the invention, the organic ice layers interact with energetic electrons in a way so that the resulting product, i.e. one or more voxels, remains essentially intact and stable under ambient conditions, i.e. when the one or more voxels are brought to for example room temperatures. The electron energy may be between 1 keV and 30 keV, such as between 1 keV and 20 keV, such as between 2 keV and 15 keV, such as between 3 keV and 10 keV. It should though be noted that the electron energy may, in general, vary between 10 eV and 300 keV. There are also secondary electrons generated through in-elastic electron matter interactions. The secondary electrons may have an energy up to 50 eV. Both energies need to be larger than the few eV what is needed to ionize electrons in the outer shell in most atoms comprised in the organic ice layers.

With respect to pore sizes in the digital representation these pore sizes may be in the sub-micrometer range, such as between 10 nm and 1000 nm, such as between 100 nm and 800, such as between 200 nm and 600 nm.

As mentioned above, the one or more voxels remain essentially intact when being exposed to ambient conditions thanks to tight chemical bonds formed between the atoms comprised in the organic ice layers while the unexposed parts of the organic ice layers will sublimate. Ambient conditions may typically refer to a normal, uncontrolled atmospheric pressure, room temperature and normal humidity values. These conditions may typically be fulfilled as soon as the sample is withdrawn from the vacuum chamber, i.e. taken outside the vacuum chamber.

In a second aspect the present invention relates to a 3D printer for printing a digital representation of a 3D structure in a stacked arrangement of organic ice layers, the 3D printer comprising
a) a cryosystem arranged in a high vacuum chamber,
b) a gas injection system for introducing a vapour into the high vacuum chamber in order to form organic ice layers in a consecutive manner,
c) a scanning electron microscope for generating an e-beam,
d) a temperature control system for controlling the temperature of the cryosystem and controlling the gas injection system, and
e) a 3D ice lithography control system for controlling the scanning electron microscope in response to G-codes derived from the digital representation of the 3D structure to be 3D printed, and for controlling the gas injection system.

Thus, the second aspect of the present invention relates to a 3D printer for performing the method of the first aspect. For that reason the implementation of the cryosystem, the high vacuum chamber, the gas injection system etc. may be implemented as disclosed in relation to the first aspect.

The implementation of the temperature control system for controlling the temperature of the cryosystem and controlling the gas injection system, and the 3D ice lithography control system for controlling the scanning electron microscope in response to G-codes derived from the digital representation of the 3D structure to be 3D printed, and for controlling the gas injection system are based on modifications of commercially available temperature control systems and control systems for 3D printers, respectively.

In a third aspect the present invention relates to a method for 3D printing a digital representation of a 3D structure, the method comprising the steps of
a) providing a first organic layer on the surface of a substrate;
b) exposing at least part of the first organic layer to at least one electron beam thereby forming one or more voxels in the first organic layer; wherein the one or more voxels is/are arranged in accordance with a first predetermined pattern;
c) providing a second organic layer on the surface of the first organic layer;
d) exposing at least part of the second organic layer to at least one electron beam thereby forming one or more voxels in the second organic layer, wherein the one or more voxels is/are arranged in accordance with a second predetermined pattern; and
e) bringing the first and second organic layers to elevated temperatures in order to evaporate nonexposed regions of the first and second organic layers;
   wherein the first and second predetermined patterns are defined by respective first and second G-codes derived from the digital representation of the 3D structure to be 3D printed.

Thus, also the third aspect of the present invention relates to a method for 3D printing a digital representation of a 3D structure. The present invention is advantageous in that the use of G-codes facilitates that a very large number of organic layers, such as several hundreds of organic layers, may be used. The method according to the third aspect is furthermore advantageous in that it may be carried out at room temperature.

Similar to the first aspect the term “condensing” should be understood as transforming a compound from a fluid phase to a solid phase.

Also in this aspect of the invention a G-code should be understood as (x,y) coordinates that, in a given z-plane, define the predetermined pattern to be followed by the at least one electron beam. The entire G-code file is generated when slicing the 3D structure to be printed into a stacked arrangement of layers of (x,y) coordinates. Again, the HPGL, or similar approaches, is considered G-codes.

The present invention is advantageous in that the use of G-codes facilitates that a very large number of organic layers, such as several hundreds of organic layers, may be used. Thus, the method may further comprise the steps of forming additional organic layers in accordance with step a), exposing each of these additional organic layers in accordance with step b), and evaporating nonexposed regions of these additional organic layers in accordance with step e). In fact the method may further comprise the steps of forming at least 10, such as at least 50, such as at least 75, such as at least 100, such as at least 150, such as at least 200, such as at least 300, such as at least 400, such as at least 500 additional organic layers in accordance with step a) and exposing each of these additional organic layers in accordance with step b), and evaporating nonexposed regions of these additional organic layers in accordance with step e). In general the organic ice layers may comprise different chemical compositions. Thus, as an example, the first organic ice layer may comprise a first chemical composition, and the second organic ice layer may comprise a second chemical composition, wherein the first and second chemical compositions are different.

The one or more voxels may have dimensions between 10 nm and 10000 nm, such as between 10 nm and 1000 nm, such as between 100 nm and 500 nm in a plane of the first, second and/or additional organic ice layers. The term “plane” is here to be understood as the extension of the organic ice layers essentially perpendicular to the growth direction during condensation of the vapour.

In relation to the third aspect the first, second and/or additional organic layers may comprise wax (C₃₀H₆₂) layers. Alternatively, or in combination therewith, the first, second and/or additional organic ice layers may comprise renewable chemicals, ethanol ice layers, nonane ice layers and/or fatty acids ice layers originating from vegetable oils.

Typically, the vapour may be introduced into a high vacuum chamber via a gas injection system which may comprise a nozzle designed to control the vapour flow as it enters the vacuum chamber. Once the vapour gets in contact with the substrate it will be condensed into an organic layer.

The substrate may have a planar surface, but may as well have a surface which is nonplanar. Despite the nonplanar surface of the substrate the organic layer will stick to the surface due to a good adhesion between the surface of the substrate and vapour deposited. Typically, the substrate may comprise a wafer, such as a standard 100 mm wafer. The wafer material may be silicon or other types of materials.

Once condensed, the organic layers preferably have a vapour pressure smaller than the pressure in the high vacuum chamber in order to prevent sublimation. A thickness of the organic layers may be controlled both by controlling the temperature of the substrate and by controlling the amount of vapour introduced to the vacuum chamber.

In case the first, second and/or additional organic layers comprise wax (C₃₀H₆₂) layers, the temperature of the substrate may be around 300 K during establishing of the organic layers and while being exposed to the at least one electron beam. During method step e), where the organic layers are brought to elevated temperatures in order to evaporate nonexposed regions of the organic layers, the temperature of the substrate may be heated up to around 350 K.

An electron beam is considered a stable and well-focused beam of electrons with a high beam current and high energy. The electron beam may change the chemical structure and thereby the chemical composition of the exposed regions of the organic ice layers. According to the invention, the organic ice layers interact with energetic electrons in a way so that the resulting product, i.e. one or more voxels, remains essentially intact and stable under ambient conditions, i.e. when the one or more voxels are brought to for example room temperatures. The electron energy may be between 1 keV and 30 keV, such as between 1 keV and 20 keV, such as between 2 keV and 15 keV, such as between 3 keV and 10 keV. It should again be noted that the electron energy may, in general, vary between 10 eV and 300 keV. There are also secondary electrons generated through in-elastic electron matter interactions. The secondary electrons may have an energy up to 50 eV. Both energies need to be larger than the few eV what is needed to ionize electrons in the outer shell in most atoms comprised in the organic layers.

With respect to pore sizes in the digital representation these pore sizes may be in the sub-micrometer range, such as between 10 nm and 1000 nm, such as between 100 nm and 800, such as between 200 nm and 600 nm.

In a fourth aspect the present invention relates to a 3D printer for printing a digital representation of a 3D structure in a stacked arrangement of organic layers, the 3D printer comprising
a) a substrate for supporting the stacked arrangement of organic layers,
b) a gas injection system for introducing a vapour in order to form the organic layers in a consecutive manner,
c) a scanning electron microscope for generating an e-beam,
d) a temperature control system for controlling the temperature of the substrate and controlling the gas injection system, and
e) a 3D lithography control system for controlling the scanning electron microscope in response to G-codes derived from the digital representation of the 3D structure to be 3D printed, and for controlling the gas injection system.

Thus, the fourth aspect of the present invention relates to a 3D printer for performing the method of the third aspect. For that reason the implementation of a potential high vacuum chamber, the gas injection system etc. may be implemented as disclosed in relation to the second aspect.

The implementation of the temperature control system for controlling the temperature of the substrate and controlling the gas injection system, and the 3D lithography control system for controlling the scanning electron microscope in response to G-codes derived from the digital representation of the 3D structure to be 3D printed, and for controlling the gas injection system are based on modifications of commercially available temperature control systems and control systems for 3D printers, respectively.

In general, the various aspects of the present invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

The present invention will now be described in further details with reference to the accompanying figures where

FIG. 1 shows the steps 1-6 of 3D printing in organic ice layers using an electron beam according to the invention,

FIG. 2 shows an electron-ice interactions simulations and experimental validation to determine voxel size. (A): Monte Carlo simulations on electrons injected into nonane CO₂ ice. 90% of the electron energy is deposited inside the garlic shaped green curve. (B) and (C): AFM images of single-layer-cuboids printed at 3 keV, 50 nm pitch (B) or 600 nm pitch (C), and area doses ranging from 1 to 45 mC/cm². (D): Plotting the cross-linked nonane ice thickness and the exposure area dose using pitches ranging from 50-600 nm. (E): Plotting the cross-linked nonane ice thickness and the exposure area dose using electron energies ranging from 3-10 keV,

FIG. 3 shows a 3DIL process model. (A): Cross-linking of organic ice into garlic shaped voxels, and layers are formed by overlapping voxels. (B): Thinner layers are formed by using a lower dose. (C): 3DIL model illustrating unique capabilities that are (i) freely suspended structures that does not need support structures, (ii) hanging structures, and (iii) enclosed cavities such as tubes,

FIG. 4 shows a schematic diagram of a nanoscale 3D printing system according to one embodiment of the invention, where (A) shows a diagram of the 3DIL system, (B) shows the 3DIL printing control program (PCP) diagram, and (C) illustrate the electron beam movement, electron beam dwell time, pitch and line width. Here, the 11 line segments correspond to 11 g-code instructions,

FIG. 5 shows 3DIL results. (A): SEM image of 3D printing test structures with suspended beams. (B): Tilted cuboids show layer-by-layer processing. (C): high aspect ratio cuboids and spaces. (D): A tower consists of 500 layers and 28 μm tall. (E): Distortion-free printing on a 150×150 μm² area. The unit cells are automatically arranged and rotated by slicing freeware for print area optimization. (F): Freely suspended, fully stretched, “hanging” tip wing without supporting structures. (G): Evaporation of ethanol-filled microchannels. (H): 2.5-μm-thick layers printed at 10 keV,

FIG. 6 shows 3DIL woodpiles. (a): Lattice units and layers of two different woodpile designs (#1 and #2). (b) and (c): Optical images (left) and SEM images (right) of the woodpiles before (b) and after (c) thermal annealing. (d): Comparing reflectance spectra of woodpiles,

FIG. 7 shows printed 3D structures according to the invention using ethanol ice, and

FIG. 8 shows an inversely-designed single-piece axisymmetric meta lens which may be produced as a 3D structure according to the invention. The lens exhibits a numerical aperture of NA=0.9, an absolute transmission efficiency (TA)>0.8 and diffraction-limited focusing.

### DETAILED DESCRIPTION OF THE INVENTION

According to the present invention, a 3D ice lithography (3DIL) process that prints in the TPL scale range and bridges the scale gap between FEBID and EBAM is provided.

The present invention is advantageous in that it facilitates that different types of chemistry associated temperatures may be applied. Moreover, the size of the voxels induced in the organic layers as well as the organic layer thickness may be controlled. In general, the size of the voxels (waist dimensions) may be between 10 nm and 10000 nm, such as between 10 nm and 1000 nm, such as between 100 nm and 500 nm. The waist dimensions of the voxels extend in the plane of the organic ice layers, i.e. perpendicular to the growth direction of the organic ice layers. The height of the voxels, i.e. the height in the growth direction of the organic ice layers, preferably matches the thickness of the organic layer being exposed. The thickness of the organic layers may be up to a few of microns, and the thickness of each organic layer may be controlled with a 10 nm accuracy.

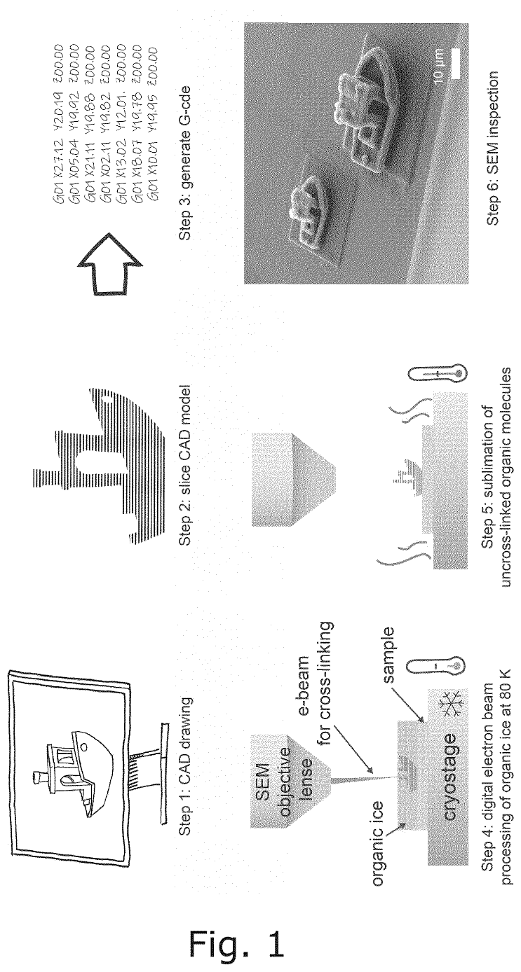

FIG. 1 illustrates the 3DIL digital process of 6 steps to print a “benchy boat” that is 54-μm-long, 38-μm-tall and contains 150 layers. The first three processes are shared with fused deposition modelling (FDM), while the final 3 processes are unique for 3DIL. The process required five research topics and technology innovations; (i) Monte Carlo simulations (MCS) of electron-ice interactions and electron exposure dose tests to determine the voxel size; (ii) establishing a 3DIL process model; (iii) the adaptation of an affordable and compact scanning electron microscope (SEM) into a 3DIL printer (25); (iv) a communication system connecting the 3DIL printer components, and (v) dedicated firmware that reads G-code from a sliced 3D CAD drawing and controls the 3DIL printer. In the following, steps i, ii and v are disclosed in detail, and steps iii and iv are briefly disclosed.

### Electron-Ice-Interaction Simulations and Voxel Size Determination

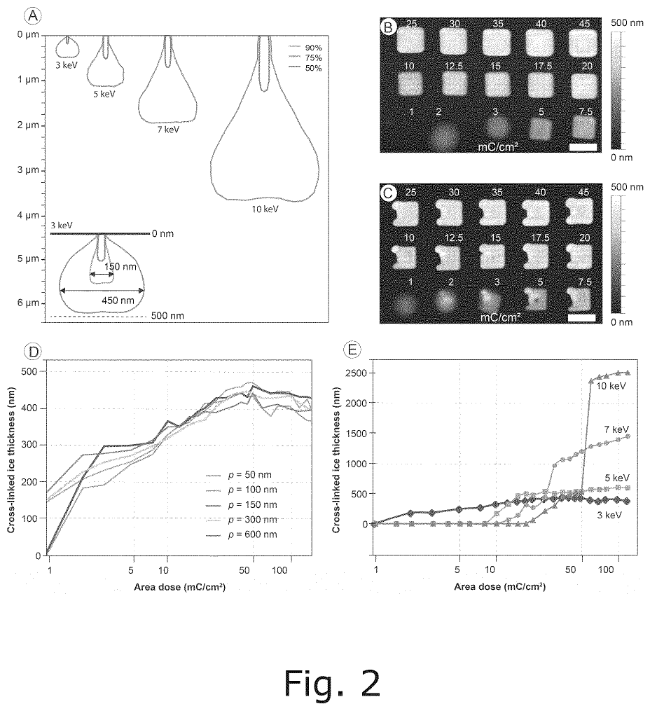

Commonly for all 3D printing processes, the 3DIL voxel needs to be determined. In the present invention predictive MCS of electron-ice interactions and experimental validation are combined, cf. FIG. 2. The energy loss (−dE) of the primary electron (PE) from the e-beam along its path (ds) in the ice is given by the Bethe equation.

$$- \frac{dE}{ds} = \frac{{NZe}^{4}}{8 π {E}_{0} {∈}_{0}^{2}} {ln ( \frac{4 {E}_{0}}{I} )}^{1 / 2}$$

where N is the number of atoms per unit volume, which is proportional to density, Z is the atomic number, E₀ is the primary electron energy, and I is the mean ionization energy defined as I=(9.76+58.8 Z^{-1.9}) Z. Based on the Bethe equations, the PE trajectory and its energy loss are visualized with MCS, cf. FIG. 2A.

In the simulation, the e-beam diameter is set to 50 nm, and the primary exposure electron (PE) energy is set to 3, 5, 7, and 10 keV, cf. Table 1 below. These energy levels are suitable for the compact thermal emission SEM.

For nonane ice, the interaction volume has a garlic shape. From the 3 keV simulations, cf. FIG. 2A, 50% of the initial PE energy is deposited in a cylinder that is 150 nm tall and 80 nm in diameter, and 95% of the energy is contained in the top 500 nm of the ice. Thus, the simulated 3 keV PE voxel has a garlic shape, with a waist diameter of 500 nm, and it is 500 nm tall.

The following very important fundamental difference should be noted: for electron beam lithography (EBL) and organic ice resist studies it is known that the e-beam only deposits a tiny fraction of its energy in the resist or organic ice, and most energy is deposited in the underlying substrate, while in 3DIL, the entire PE energy is deposited in the organic ice.

The cure depth for 3 keV was measured and the pitch was varied between 50 and 600 nm, cf. FIGS. 2B and 2C. The dose test was performed with an array of identical square patterns exposed with different area doses, and the ice thickness (1 μm) is double the anticipated e-beam penetration depth. For 50-nm-pitch, at doses below 3 mC/cm², the squares are deformed, and their position is shifted from their intended position, which is discussed later. The cross-linked nonane (CLN) thickness or cure depth (Cd) was between 150 and 430 nm, and the surface was smooth. At doses above 10 mC/cm², the printed structure geometry is identical to the design, and the square positions are slightly shifted. The maximum CLN thickness (dₘₐₓ) was 430 nm, similar to the MCS results. For 600 nm pitch, the “top of the garlic” and a rougher surface was observed. The digital process causes the missing left edge.

The dose test measurement is used to plot dose curves, cf. FIG. 2D. The CLN thickness increases with dose and plateaus at 430 nm, and decreases slightly at above 100 mC/cm². Hence, the 3DIL process is very robust if printed at 3 kV and 10 mC/cm² because dose variations will not significantly affect the final print. The pitch only has a minor influence on the dose and CLN thickness. While 3DIL Cd saturates and becomes independent of the dose, Cd for photopolymerization processes increases exponentially with the dose and does not saturate, because of the amplification effects of polymerization. Thus, for Cd, 3DIL is more robust than photopolymerization because small dose fluctuations will not influence print quality. The dose curves for 3, 5, 7, and 10 keV PE electrons are plotted in FIG. 2E. For 3 and 5 keV, the plots matched well with the simulations. For 7 and 10 keV, the CLN thickness saturated at 1400 nm and 2500 nm, respectively. Each plot shows one abrupt change, and this is caused by the smearing of low-dose prints.

Thus, it is possible to predict and select the voxel size by MCS and adjusting the electron energy. For example, exposing nonane at 3 keV and 10 mC/cm², the vertical voxel size is 430 nm, and the lateral size is 450 nm, cf. FIG. 2A. Using the compact SEM to process nonane ice, voxel sizes ranging between 500 to 2500 nm can be selected by changing electron energy between 3 and 10 keV. Advanced SEMs are expected to have a larger voxel size range. Compared to TPL, the TPL voxel has an ellipsoid shape, the minimal vertical size is 1000 nm, and the minimal lateral size is 300 nm. The 3DIL voxel size can be increased by changing exposure parameters.

TABLE 1
Printing parameters for electron energies between 3 and
10 keV. The critical area dose (CDA) is the area dose
required to cross-link ice with a thickness of 80% dₘₐₓ
(or critical thickness, dc) for given e-beam energy.
The critical volume dose (CDV) is 2CDA/dₘₐₓ.

| | simulated | measured | | |
|---|---|---|---|---|
| | dₘₐₓ | dₘₐₓ | CDA | CDV |
| keV | (nm) | (nm) | (mC/cm²) | (C/m³) |
| 3 | 500 | 420 | 5 | 2 · 10⁸ |
| 5 | 1100 | 600 | 12.5 | 4 · 10⁸ |
| 7 | 2000 | 1500 | 27 | 4 · 10⁸ |
| 10 | 3600 | 2500 | 60 | 5 · 10⁸ |

### 3D Ice Lithography Process Model

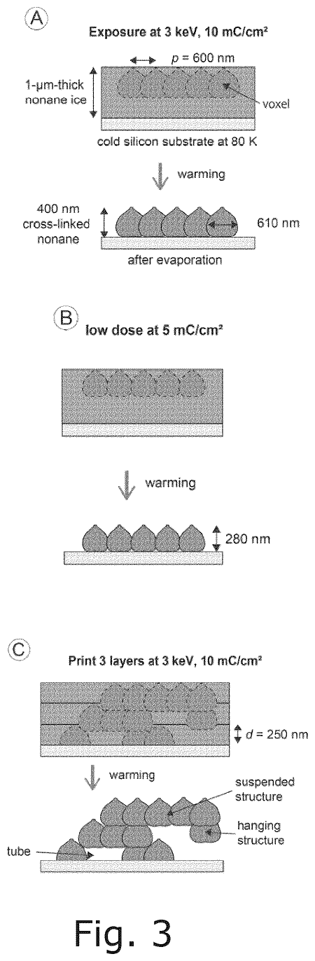

ii): From the MCS and experimental validation of the electron-ice-interactions, a 3DIL process model is presented, cf. FIG. 3. When exposed at a higher dose (3 keV, 10 mC/cm²), cf. FIGS. 3A and 3C, the voxel is the entire garlic-shaped electron ice interaction volume. When exposed at a lower dose (5 mC/cm²), cf. FIG. 3B, the interaction volume is the same, but only the centre reaches CDA for cross-linking, yielding a thinner CLN layer. Because the CLN layers are not attached to the substrate, their position might slightly shift, which is observed in the dose tests, cf. FIG. 2B. A small pitch leads to a smooth surface. Approximately half of the CLN thickness (250 nm) is set as d, and each layer will receive about twice the applied dose accumulatively.

Another approach is to print at CDA and dc. E.g., for 3 keV, 5 mC/cm² is used and d is set to 200 nm. The total dose for each layer will be slightly above 5 mC/cm², and printing is about four times faster. However, the print reproducibility might be compromised because the geometries are much more sensitive to dose variations. Interestingly, the CDV for 10 keV is two times larger than CDV for 3 keV (Table 1). Hence, it appears that the fastest printing happens at the lowest PE energy, however, since most SEMs provide much more e-beam current at higher PE energies, the fastest printing is at the highest PE energy.

In addition to 3DIL being compatible with non-photopolymer chemistry, the process model shows that 3DIL complements TPL in three areas. Firstly, 3DIL can print fragile and suspended structures because liquid-to-air interfaces are avoided, where strong capillary force will dominate and destroy microstructures. Secondly, 3DIL allows “hanging” structures, which is impossible with TPL because unattached structures move freely in liquids. Thirdly, tubes and capillaries are possible because uncross-linked organic molecules sublimate readily from narrow and partially enclosed structures.

Tubes are very difficult to make using TPL because the viscous TPL liquid photopolymer is difficult to remove from high-aspect-ratio tubes. Furthermore, because TPL uses viscous liquid photopolymer resin, critical point drying post-processing and great care must be provided when drying delicate devices. These advantages are demonstrated later.

### Firmware for 3DIL Process Control

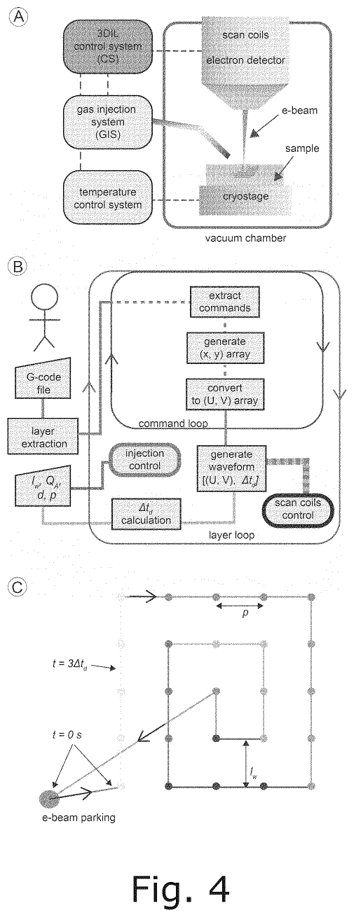

(iii): The 3D IL printer is based on a compact SEM to provide the required e-beam and vacuum chamber, cf. FIG. 4A. A cryostage is installed into the SEM to cool down the process substrate to 80 K. The precursor gas is regulated through a custom automated gas injection system (GIS) module connected to a nozzle inside the SEM.

(iv): The SEM, GIS, and stage temperature control systems are connected to the 3DIL control system (CS). The CS controls the SEM scan coils and gets input from the electron detectors, which allows us to take SEM images and controls the position of the e-beam. The CS reads and controls the GIS for automatic precursor injection and ice thickness control.

(v): The CS is controlled using the 3DIL printing control program (PCP) that automates the 3DIL gas injection and e-beam exposure sequences, cf. FIG. 4B. The PCP is compatible with most industrial 3D printing and AM digital manufacturing, which enables it to leverage with advanced digital AM software toolbox and 3D CAD databases. Thus, the PCP is completely different from electron-beam lithography that uses the electronic design automation data format (e.g. GDSII, CIF, GERBER), and FEBID that need uniquely developed software and require electron-gas-surface interactions simulations for every voxe. For 3DIL printing, the user must calibrate the GIS and the precursor ice thickness. After initial calibration, the user needs to give 5 inputs:
1) a g-code file,
2) an area exposure dose (Qa),
3) e-beam current (Ie),
4) pitch size (p), and
5) layer thickness (d).

The G-code file is generated when slicing a 3D CAD file using freeware (e.g. Ultimaker CURA), and the user needs to input d and the line width, Iw. For this work, p=Iw. QA, p, and Ie are used to calculate the e-beam dwell time (Δtd), and writing time.

The PCP reads the g-code, and extracts the instructions needed to print each layer. Each g-code instruction line contains the operation code and target coordinates, which the PCP uses to guide the e-beam to the designated positions to cross-link the ice. The PCP contains two loops. The “layer loop” prints a layer and starts with the injection control, which operates the GIS, and condenses an ice layer on the sample. The “command loop” follows and iterates for each g-code instruction line within a layer and extracts all target coordinates. For each g-code target coordinate, the PCP generates an exposure path that consists of exposure points corresponding to the voxels.

All voxel coordinates within a layer are encoded in an (x,y) coordinate array, cf. FIG. 4C. The length of the g-code vectors and p determines the size of the array. The (x,y) array is then converted to a (U, V) voltage array. Thus, each layer generates an array of (U, V) signals. Via the CS, the voltage signals and Δtd control the SEM scan coils for e-beam positioning, dwelling, and accurate ice cross-linking.

As already discussed, the HPGL (and similar approaches) is considered G-codes as it is a vector-based graphic tool suitable for controlling for example printers, plotters and other output devices, including electron beams.

### 3D Printing Results

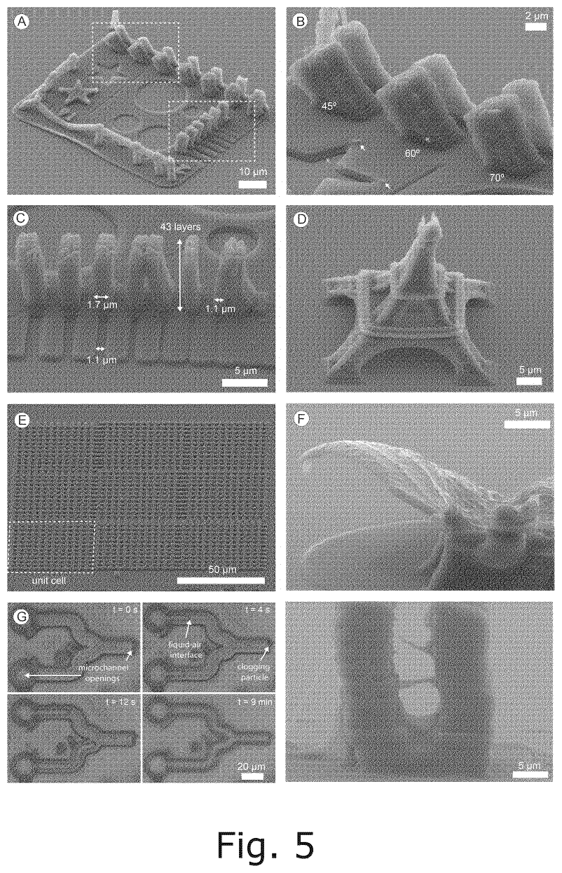

Having established the 3DIL model, printer, controls and software, 3D test structures were printed at 3 keV with d=250 nm, p=50 nm, and 43 layers in total, cf. FIG. 5A. A higher magnification image, cf. FIG. 5B, shows tilt angles up to 45°, and end-supported horizontal beams 1.5-μm-wide, 2-μm-thick, and 7-μm-long are successfully printed.

FIG. 5C shows high-aspect-ratio cuboids 1.1-μm-wide and 11-μm-tall. Cuboids above 1.5-μm-wide showed good integrity, while thinner cuboids rested on others or collapsed. If the design is 1.5 μm wide, the printed structure is 1.7 μm wide, and the spaces between structures are 1.1 μm wide. The errors are caused by the electron-ice interaction volume and the digital slicing. The surface quality of the first 3 layers is very smooth, see also FIG. 2b. However, there are also a few semispherical protrusions, cf. FIG. 5B, likely microscopic gas bubbles caused by impurities from the vacuum chamber, impurities from the nonane or gasses generated during the cross-linking process.

Photopolymerization processes also generate gasses, and they need to diffuse out to avoid bubble formation. The accumulation of bubbles results in a rough top surface, which might be improved by an optimized printing process for controlled gas diffusion. Bubbles can also be avoided using an organic molecule that generates less gas when cross-linked.

Occasionally, misalignment between layers is visible, cf. FIG. 5B. The misalignment is measured to be less than 200 nm. This is caused by cryostage drift, and thanks to the SEMs imaging capabilities, automatic image and alignment algorithms might compensate for the drift. Print smearing is anticipated due to e-beam defocusing for structures taller than 10 μm, which is the depth of focus of the SEM. To test this, the Eiffel tower was printed which is 28 μm tall, and the smallest structures were 550 nm wide, cf. FIG. 5D. As anticipated, the first 10 μm were printed with good quality, while the final 20 μm were smeared such the tower became slightly tilted and the narrow beams merged. Thus, focus compensation is needed to print structures with large heights or fine features. To test distortions, FIG. 5E shows a 150×150 μm² print consisting of 9 unit cells, and there are no distortions. From the 3DIL model and the 3D print tests, it should be possible to print suspended, fragile, and “hanging” structures, which is demonstrated by printing a dragon with a wing that is 900-nm-thin and stretching 16 μm away from the body, cf. FIG. 5F. Hanging structures can be challenging with TPL, however, because of destructive interfacial forces during drying, fine structures must be supported.

The tip of the wing is a “hanging” structure which is impossible with photopolymer-based 3D printing. To demonstrate that 3DIL can print hollow structures, microfluidics channels were printed which have important applications in, e.g. point-of-care diagnostics and organs-on-a-chip. Mimicking blood capillaries, microchannels were printed with an inner diameter between 3.5-6.4 μm and filled them with ethanol, cf. FIG. 5G. As the ethanol started to evaporate from the free channel openings, the liquid-air interface moved towards the centre of the channels, and eventually, all the ethanol in the channels dried out.

Moreover, 3D structures at 10 keV and 2.5 μm-thick-layers were printed to demonstrate the freedom to select and adjust the voxel size, cf. FIG. 5H. Finally, to show that the 3DIL process is compatible with metal-organic chemistry, gold-containing organic chemicals were printed.

Thus, according to the present invention this is the first AM electron processing of organic ice that applies a digital manufacturing paradigm and integrates physical modelling, 3D CAD modelling, slicing, and layer-by-layer printing.

To demonstrate size-dependent nanophotonic effects, woodpile structures which are often applied for photonic crystals (PhC) and mechanical metamaterials were printed. Woodpiles are made by two-photon lithography (TPL) or complex iterative lithography and plasma etching. It was aimed to demonstrate lattice size-dependent scattering differences in the UV range.

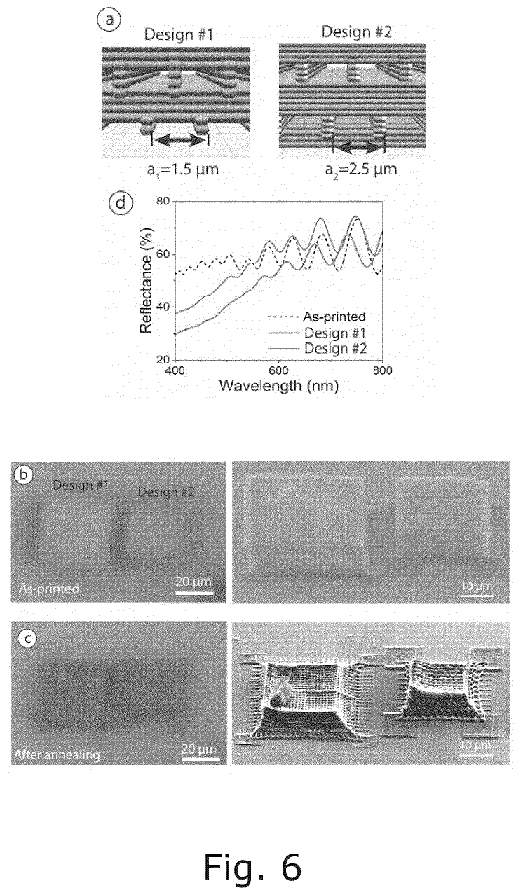

The lattice unit sizes are 1.5 μm and 2.5 μm for designs #1 and #2,respectively, cf. FIG. 6a. Design #2 is anticipated to have a different effect than design #1. Using 3DIL and diesel as the precursor two woodpiles consisting of 70 layers were printed, cf. FIGS. 6b and 6c. Each layer has a thickness of 200 nm. The woodpiles were annealed in argon (1 bar) at 300° C. for 10 min to decrease the lattice size. As anticipated, the woodpiles changed from a white to a reddish colour after annealing, cf. FIG. 6c. SEM analysis, cf. FIGS. 6b and 6c (right images), shows that the woodpiles laterally shrunk by 31% (design #1) and 33% (design #2). The vertical shrinking was 42%.

Reflectance spectra were measured by a microspectrophotometer, cf. FIG. 6d. For as-printed structures, the reflectance spectrum shows a uniform reflectance in the visible wavelengths, which gives a “white” color. The interference fringes are due to thin-film interference. After annealing, the lattice size is reduced, and cause a smaller reflectance or higher absorbance in the UV-range, which is observed as a “reddish” color. As for larger unit size (design #2), the absorption is less for incoming light in UV-range, leading to a spectrum slightly blue-shifted. This size dependent structural color is different in mechanism compared with 3D photonic crystals.

The inventors have presented 3DIL using nonane as the starting material and 3D printed structures up to 150 μm wide and 28 μm tall. The layer thickness range between 250 nm to 2.5 μm. The finest lines were 550 nm wide. 3DIL bridges the scale gap between FEBID and EBAM, which are both e-beam-based 3D printing. With minor adaptations, 3DIL instruments can be modified to enable FEBID, it is straightforward to combine FEBID and 3DIL to 3D print structures between 1 nm to 100 μm. 3DIL can also be scaled up using more powerful EBAM machines (16). Because 3DIL is based on cross-linking processes rather than polymerization processes, 3DIL through-put is inherently much lower than stereolithography, TPL and other photopolymerization AM processes. 3DIL complements photon polymerization processes nicely because 3DIL can facilitate chemical reactions and potentially 3D printing using chemicals from the other three organic chemistry branches; organometallic, organic semiconductor, and medicinal chemistry.

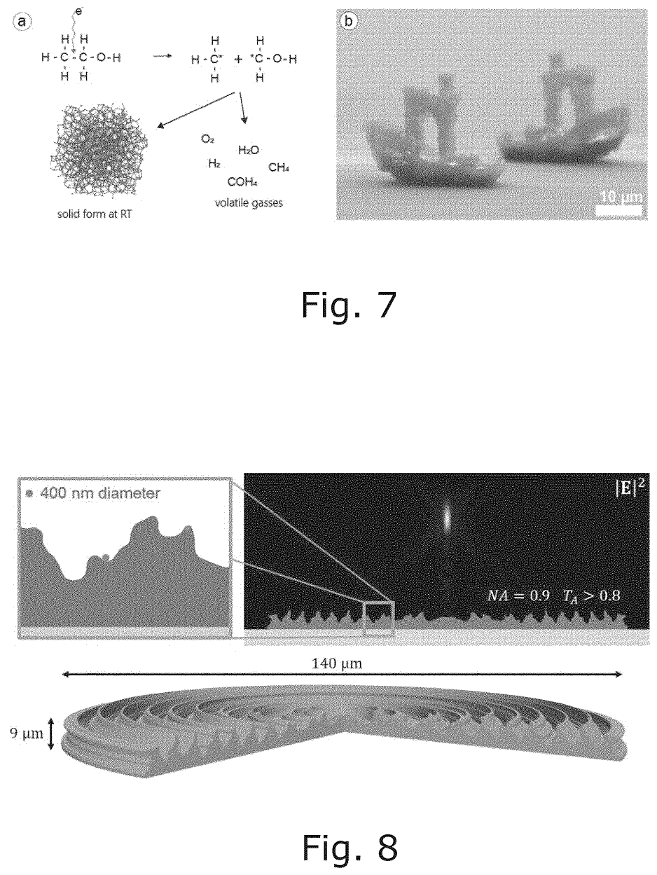

The inventors have further-using the present invention-printed 3D structures, cf. FIG. 7, using ethanol, which is a renewable chemical. Energetic electrons in the interval of 3-20 keV interact with the ethanol ice and radicals are formed, which then react with other ethanol molecules and form cross-linked molecules that are solid at ambient conditions. The electron energy needed to cross-link ethanol is about 10 times larger than for nonane. The small ethanol molecules thus seem to require a much higher cross-linking, about 10 times, to remain stable at ambient temperature. Compared to nonane, the cross-linked ethanol structures were very porous. This is most likely due to gases and volatile ethanol fragments generated during the cross-linking process. The pore size is sub-micrometer, such as between 10 nm and 1000 nm, such as between 100 nm and 800, such as between 200 nm and 600 nm, and such devices can e.g. be used as biofilters in lab-on-chip and organ-on-chip applications.

FIG. 7a depicts the chemistry when electrons interact with ethanol ice when producing according to the invention. The energetic electrons cause bond scission, and hydrocarbon radicals are created. The radicals may recombine, react with other molecules (cross-link) to form larger networks that are solid networks, or form volatile gasses. For ethanol ice, cross-linking and formation of volatile gas evolution takes place simultaneously. In FIG. 7b are shown SEM images of cross-linked ethanol ice “benchy boat” with many pores.

Moreover, FIG. 8 shows a single-piece axisymmetric meta lens which may be produced by the present invention. When evaluated numerically, this metal lens exhibits high transmittance (T>0.8), diffraction-limited focusing and a high numerical aperture (NA~0.9). To fabricate this meta surface as a 3D generated structure is a significant step toward for the field of flat optics. The single-piece axisymmetric meta lens reproduced here is 9 μm thick and 140 μm in diameter and it may consist of 180 organic ice layers each having a thickness of 50 nm. Different chemicals have different dielectric properties, and hence different refractive index. The refractive index can be tuned by selecting a suitable chemical. E.g. cross-linked nonane is similar to poly(ethylene) while cross-linked aromatics would be similar to poly(styrene).

The inventors consider it possible to by the invention to achieve a decrease of the voxel sizes, such as from 500 nm to 100 nm. Voxel sizes around 100 nm would allow sustainable fabrication of photonic crystals in the visible wavelength, and one may then entirely be able avoid energy-intensive high-temperature post-processing.

Prototyping and production of MEMS devices might also be impacted by lowering the entry barrier for small-scale, more economical, and sustainable productions. The present invention may also pave the way for medium-scale production machines by integrating and adapting multi-e-beam electron-beam lithography with 250000 beams, which is used for EUV lithography mask production. Taken together, the inventors believe that the present invention has the potential to become a sustainable manufacturing process for small and medium-scale MEMS sensor production.

In the future, the inventors envisage more work to be done in relation to investigate which renewable chemistries are suitable as good vapour candidates to provide long time durable and stable 3D structures. The data on the ethanol ice results, cf. FIG. 7, are promising. more work is suggested to print non-porous structures, which can be achieved when using larger molecules in the vapours—for example such as fatty acids e.g. originating from vegetable cooking oils. However, unlike ethanol, these biochemicals have very low vapor pressures at room temperature, and to use fatty acids as a precursor they need to be heated to increase the vapor pressure. Although being heated the temperature should not exceed the boiling point which is about 200 degrees C. The vapor pressure should not exceed 100 mbar.

The addition of another chemical to the GIS currently available is difficult presently as they tend to generally only accommodates one material. Accordingly the inventors suggest to provide GIS with the possibility to mix two or more chemicals therein.

Such a redesign of the GIS that would also allow materials heating to 100° C., such that fatty acids could be used for 3DIL, is therefore desirable.

Significant control and software development are needed. For example, the GIS needs to control different gases for multi-material printing. The GIS must also mix gases and obtain the desired stoichiometries for direct electron injection chemical reactions.

The inventors will optimize the processes to improve the instrument and reach KPIs. Process parameters are electron energy, ice thickness, dose, electron beam current, etc.

Although the invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

1.-32. (canceled)

33. A method for printing a 3D structure according to a digital representation, the method comprising:
forming a plurality of organic layers;
forming one or more voxels in of each of the plurality of organic layers according to the digital representation comprising exposing at least a portion of each of the plurality of organic layers to an area dose mC/cm² sufficient to form said one or more voxels; and
evaporating nonexposed regions of each of the plurality of layers,
wherein the plurality of organic layers comprises at least a first organic layer and a second organic layer,
wherein each organic layer comprises at least one organic compound,
wherein the forming of the plurality of layers comprises forming the first layer onto a substrate followed by sequentially forming each of the remaining of the plurality of organic layers onto a previously formed organic layer,
wherein the exposing of at least the portion of each of the plurality of organic layers to the area dose mC/cm² comprises exposing at least the portion of each of the plurality of organic layers to the area dose mC/cm² before forming a subsequent organic layer of the plurality of organic layers,
wherein the forming of one or more voxels in the exposed portion of each of the plurality of organic layers comprises forming the one or more voxels to be arranged according to a layer-specific predetermined pattern derived from the digital representation.

34. The method of claim 33, wherein the plurality of organic layers comprises one or more additional organic layers.

35. The method of claim 33, wherein the plurality of organic layers comprises at least 10 additional organic layers.

36. The method of claim 33, wherein each organic layer, independent of each other has a thickness of from 200 nm to 2.5 μm.

37. The method of claim 33, wherein the forming of each of the plurality of organic layers comprises condensing a vapour comprising the at least one organic compound to form the organic layer.

38. The method of claim 33, wherein the forming of each of the plurality of organic layers is performed at a temperature of at least room temperature.

39. The method of claim 33, wherein the forming of each of the plurality of organic layers is performed without cryogenic cooling and wherein non-exposed regions are evaporated by heating.

40. The method of claim 33, wherein the plurality of organic layers comprises organic ice layers.

41. The method of claim 33, wherein the forming of each of the plurality of organic ice layers comprises condensing a vapour comprising the at least one organic compound to form each respective organic ice layer.

42. The method of claim 40, wherein the forming of the first layer comprises condensing a vapour comprising the at least one organic compound onto the substrate to form the first organic layer to be a first organic ice layer, wherein the substrate is a cooled substrate.

43. The method of claim 42, wherein the cooled substrate is cooled to a temperature of 200 K or below.

44. The method of claim 42, wherein the cooled substrate is arranged on a cryosystem arranged in a high vacuum chamber.

45. The method of claim 33, wherein the exposing at least a portion of each of the plurality of organic layers to an area dose mC/cm² comprises for each layer irradiating said portion of the organic layer with a charged-particle beam.

46. The method of claim 33, wherein the exposing at least a portion of each of the plurality of organic layers to an area dose expressed in coulombs per square centimeter comprises for each organic layer of the respective organic layers of the plurality of organic layers exposing at least the portion of said organic layer to an area dose in the ranging from 1 to 45 mC/cm².

47. The method of claim 33, wherein the area dose is selected to achieve a selected layer cure depth.

48. The method of claim 33, wherein the exposing at least a portion of each of the plurality of organic layers to an area dose comprises for each layer irradiating said portion of the organic layer by providing a focused charged-particle beam along an exposure path according to the layer-specific predetermined pattern.

49. The method of claim 33, wherein the exposing at least a portion of each of the plurality of organic layers to an area dose comprises for each layer irradiating said portion of the organic layer using at least one charged-particle beam.

50. The method of claim 49, wherein the at least one charged-particle beam comprises an electron beam.

51. The method of claim 50, wherein the electron beam supplies an energy to the exposed portion of from 1 keV to 30 keV.

52. The method of claim 33, wherein the forming of said one or more voxels in each the plurality of organic layers comprising applying a SEM-based electron-beam processing comprising controlling the beam motion based on the layer-specific predetermined pattern.

53. The method of claim 33, wherein the method comprises applying a sample comprising the substrate in a vacuum chamber and performing for each layer a layer loop comprising condensing an ice layer on the sample and controlling the beam motion according to an exposure path that consists of exposure points corresponding to voxel coordinates of an x,y coordinate array of the layer-specific predetermined pattern.

54. The method of claim 33, wherein the method comprises forming the one or more voxels to independently of each other have a voxel dimension determined as a waist dimension of from 10 nm to 10000 nm.

55. The method of claim 33, wherein the method comprises forming the one or more voxels have in-plane voxel dimensions of from 10 nm to 10000 nm.

56. The method of claim 33, wherein the forming one or more voxels in the exposed portion of each of the plurality of organic layers comprises cross-linking the at least one organic compound.

57. The method of claim 33, wherein the substrate has a nonplanar surface and the method comprises forming the first organic layer onto at least a portion of the nonplanar surface of the substrate.

58. The method of claim 33, wherein the one or more of the plurality of organic layers comprises one or more compounds select from the classes consisting of hydrocarbon C₆-C₁₆, sulfur containing compounds, halogen containing compounds, oxygen containing compounds, nitrogen containing compounds, polymerizable monomers, and ALD and CVD precursors for metallic layers

59. The method of claim 33, wherein the layer-specific predetermined pattern is derived from the digital representation in the form of data provided as G-codes.

60. The method of claim 33, wherein the layer-specific predetermined pattern is derived from the digital representation in the form of data comprising a set of (x,y) coordinates for each z-plane.

61. The method of claim 33, wherein the layer-specific predetermined pattern is derived from the digital representation in the form of a 3D code language comprising coordinates that, in a given z-plane, define the predetermined pattern.

62. The method of claim 61, wherein the 3D code language comprises a vector-based graphic tool suitable for controlling a 3D printer for forming the one or more voxels.

63. A 3D printer for printing a 3D structure according to the method of claim 33 in a stacked arrangement of the plurality of organic layers, the 3D printer comprising:
a substrate for supporting the stacked arrangement of organic layers;
a gas injection system for introducing a vapour in order to form the organic layers in a consecutive manner;
a charged-particle beam generator; configured for delivering a focused beam of charged particles
a temperature control system for controlling the temperature of the substrate and controlling the gas injection system; and
a 3D lithography control system for controlling the focused beam of charged particles in in accordance with the digital representation of the 3D structure to be 3D printed, and for controlling the gas injection system.

64. The 3D printer of claim 60, wherein the 3D lithography control system is a 3D ice lithography control system, wherein the gas injection system is configured for introducing the vapour into a high vacuum chamber for forming organic ice layers in a consecutive manner and wherein the 3D printer comprises a cryosystem arranged in a high vacuum chamber.
